(19) United States
(12) Patent Application Publication
(10) Pub. No.: US 2015/0149832 A1
(43) Pub. Date: May 28, 2015

(54) BUS PRESSURE TESTING SYSTEM AND METHOD THEREOF

(71) Applicants: INVENTEC CORPORATION, Taipei (TW); INVENTEC (PUDONG) TECHNOLOGY CORPORATION, Shanghai (CN)

(72) Inventor: Tian-Chao ZHANG, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 14/206,818

(22) Filed: Mar. 12, 2014

(30) Foreign Application Priority Data
Nov. 26, 2013 (CN) 2013 10612594.7

(51) Int. Cl. G06F 11/22

(52) U.S. Cl. CPC G06F 11/221
USPC 714/43

(57) ABSTRACT

A bus pressure testing system and method thereof are disclosed, where a peripheral component interconnect express (PCI-E) device is used to initialize a central processing unit (CPU), peripheral component interface express (PCI-E) device interface and memory according to a testing model, generate a data transmission path corresponding to the testing model, produce a pressure data stream by using the PCI-E device, and test a bus for its pressure by flowing the pressure data transmission stream on the data transmission path. As such, the pressure testing may be enhanced in practicability.

### BACKGROUND OF THE INVENTION

1. Field of Invention

The present invention relates to a pressure testing system and method therefor, and particularly to a bus pressure testing system and method thereof, where a peripheral component interconnect express (PCI-E) device is used to produce a pressure data stream to save a processing time of a central processing unit (CPU).

2. Related Art

For recently years, central processing unit (CPU) has its tend to integrating external buses and memories into the CPU itself, so that the CPU may directly communicate with the memory and PCI-E device.

Generally, in testing a bus pressure among the CPU, memories, and PCI-E devices, a model with the CPU as a central basis is employed, i.e. the CPU is used to test the bus pressure for the memories and PCI-E DEVICE. However, this manner may take up a large amount of time of the CPU, which makes the CPU fail to process other tests concurrently and form a meshed crossing model. The result is the pressure testing task is inconvenient in operation and poor in practicability.

For the above mentioned issue, there has been a technique proposed, in which a dual-CPU architecture is employed with one for pressure testing and the other for other tests, whereby reducing the processing time of the CPU. However, this manner also consumes the processing time of the CPU and may not form the meshed crossing model. The poor practicability of pressure testing still exists.

In view of the issue long encountered in the prior art, there is a need to set forth an effective technique to make an improvement.

### SUMMARY OF THE INVENTION

The bus pressure testing system according to the present invention is applied on a peripheral component interconnect express (PCI-E) device for testing a bus environment having at least a central processing unit (CPU), at least a PCI-E device interface and at least a memory, and comprises: an initialization module, receiving a testing model after the PCI-E device is activated and initializing the CPU, PCI-E interface and memory according to the testing module; a path module, generating a data transmission path corresponding to the testing module and comprising one of the PCI-E device interface to the CPU and the PCI-E device interface to the memory; and a producing module, producing a pressure data stream transmitted on the data transmission path for the bus pressure testing.

The bus pressure testing method according to the present invention is applied on a peripheral component interconnect express (PCI-E) device for testing a bus environment having at least a central processing unit (CPU), at least a PCI-E device interface and at least a memory, and comprises steps of receiving a testing model after the PCI-E device is activated and initializing the CPU, PCI-E device interface and memory according to the testing module; generating a data transmission path corresponding to the testing module and comprising one of the PCI-E device interface to the CPU and the PCI-E device interface to the memory; and producing a pressure data stream transmitted on the data transmission path for the bus pressure testing.

The bus pressure testing system and method have been disclosed as the above, which has the differences as compared to the prior art that the PCI-E device is used to initialize the CPU, PCI-E device interface and memory according to the testing module, generate a data transmission path corresponding to the testing module, produces a pressure data stream and transmitting the pressure data stream on the data transmission path for the bus pressure testing.

By using of the above mentioned technical means, the bus pressure testing may be enhanced in practicability.

### BRIEF DESCRIPTION OF THE DRAWINGS

The invention will become more fully understood from the detailed description given herein below illustration only, and thus is not limitative of the present invention, and wherein:

FIG. 1 is a system block diagram of a bus pressure testing system according to the present invention;

FIG. 2 is a flowchart of a bus pressure test method according to the present invention;

FIG. 3 is a schematic diagram for illustrating a bus pressure testing process applied on an environment having a central processing unit (CPU), a peripheral component interconnect express (PCI-E) device and a memory according to the present invention; and

FIGS. 4A through 4D are schematic diagrams for illustrating a bus pressure testing process applied on an environment having multiple CPUs, multiple memories and multiple PCI-E devices according to the present invention.

### DETAILED DESCRIPTION OF THE INVENTION

In what follows, the present invention will be described in details in connection with the annex drawings and the embodiments with respect to the features and implementations thereof, which is sufficient to enable those who skilled in the art readily to realize the technical mechanism intent to solve the technical problems and implement the same, so as to achieve in the efficacy exclaimed in the present invention.

Prior to the description of the bus pressure system and method of the present invention, an environment on which the testing is performed is described herein first. The present invention is applied on a PCI-E device, and prior to the pressure testing, the PCI-E device is arranged in a bus environment having a central processing unit (CPU), a PCI-E device interface and a memory. In doing this, the PCI-E device is inserted into a slot of the PCI-E device interface. In real implementation, assume the bus environment has two CPUs each connected to two PCI-E device interfaces and two memories, four such PCI-E devices of the present invention may be inserted to use for the pressure testing. It is to be particularly noted that the number of each of the CPU, PCI-E device and memory in the bus environment may be presented without any limitation.

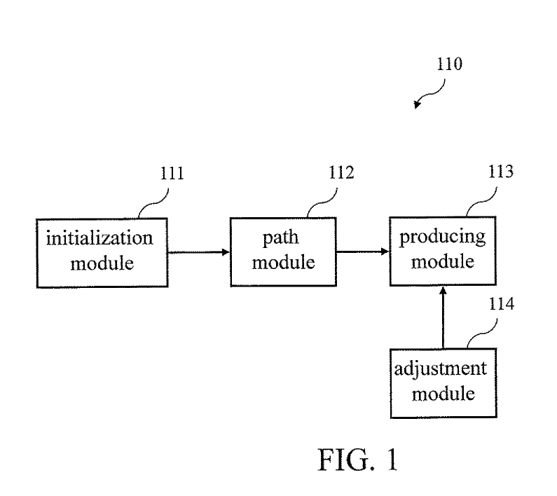

In the following, the present invention will be explained in more details. Referring to FIG. 1, which is a system block diagram of the bus pressure testing system according to the present invention. The bus pressure testing system is applied on a PCI-E device 110 to test a bus environment having a CPU, a PCI_E device interface and a memory. The system comprises an initialization module 111, a path module 112 and a producing module 113. After the PCI-E device 110 is activated, the initialization module 111 receives a testing module, and initializes the CPU, PCI-E device interface and memory according to the testing module. The testing module may be a bus test for the PCI-E device 110 and the CPU, a bus test for the PCI-E device 110 and another PCI-E device 110, a bus test for the PCI-E device 110 and the memory, and the like. In addition, the initialization process may be first detecting a data read/write address of the CPU, the memory and the PCI-E device 110, and then setting a data read/write address of the PCI-E device 110 and an address space of a base address register, or setting the data read/write address of the PCI-E device 110 and requesting an allocation of the memory. In other words, the initialization process refers to maintaining the associated CPU, memory and PCI-E device 110 in a state ready for the pressure testing.

After the initialization process by the initialization module 111, the path module 112 establishes a data transmission path corresponding to the testing model, and the data transmission path comprises one of a path between the PCI-E device interface and the CPU and a path between the PCI-E device interface and memory. For example, assume the testing model is a test between the PCI-E device and the CPU, the established data transmission path is the path between the PCI-E device interface and the CPU. Assume the test model is a test between the PCI-E device and the memory, the established data transmission path is the path between the PCI-E device interface to the memory. It is to be particularly noted that in an environment having two CPUs each connected to two PCI-E device interface and two memories, the data transmission path is one of a path between the two PCI-E DEVICE interface of a same one of the two CPUs, a path among the two PCI-E device interface and the two memories of a same one of the two CPUs, and a path among the two PCI-E device interface and the two memories of the two CPUs.

The producing module 113 is used to produce a pressure data stream and enable the pressure data stream to flow on a data transmission path for pressure testing. In real implementation, since the pressure data stream is produced by the PCI-E device 110, now a “PCI-E device Gen3 x16” is taken as an example for the PCI-E device 110. The produced pressure data stream may be a dual-directional data pressure of 16 GB/s. In addition, since the manner of producing the pressure data stream has been known to those who skilled in the art, it is omitted here for clarity.

it is to be particularly noted that the system of the present invention may further comprise an adjustment module 114 for receiving a pressure message, and triggers the producing module 113 to adjust a flow amount of the pressure data stream, a payload data size of the PCI-E device interface, a size of the memory and a size of a First In First Out (FIFO) queue according to the testing model. For example, a user may set the pressure message through an application program and drive the PCI-E device 110 to adjust the amount of the pressure data stream, such as from 16 GB/s to 8 GB/s.

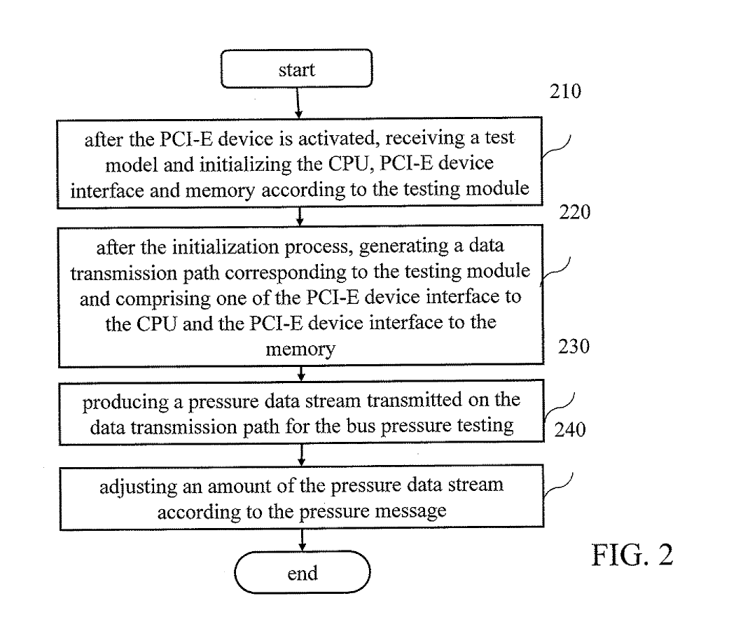

Then, referring to FIG. 2, which is a flowchart of a bus pressure test method according to the present invention. The method comprises the following steps. First, receiving a testing model after the PCI-E device 110 is activated and initializing the CPU, PCI-E device interface and memory according to the testing module (Step 210). Then, after the initialization process, generating a data transmission path corresponding to the testing module and comprising one of the PCI-E device interface to the CPU and the PCI-E device interface to the memory (Step 220). Finally, producing a pressure data stream transmitted on the data transmission path for the bus pressure testing (Step 230).

Through the above steps, the PCI-E device 110 initializes the CPU, PCI-E device interface and memory according to the testing module, generates the data transmission path corresponding to the testing module, and produces a pressure data stream and transmits the pressure data stream on the data transmission path, so as to test the bus pressure.

In addition, after the Step 230, there may be a further step of adjusting an amount of the pressure data stream according to the pressure message (Step 240). Since the adjustment of the amount of the pressure data stream has been explained in the foregoing context, it is omitted herein for clarity.

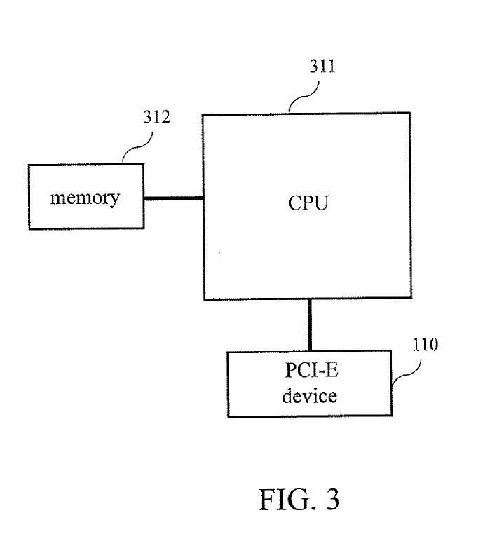

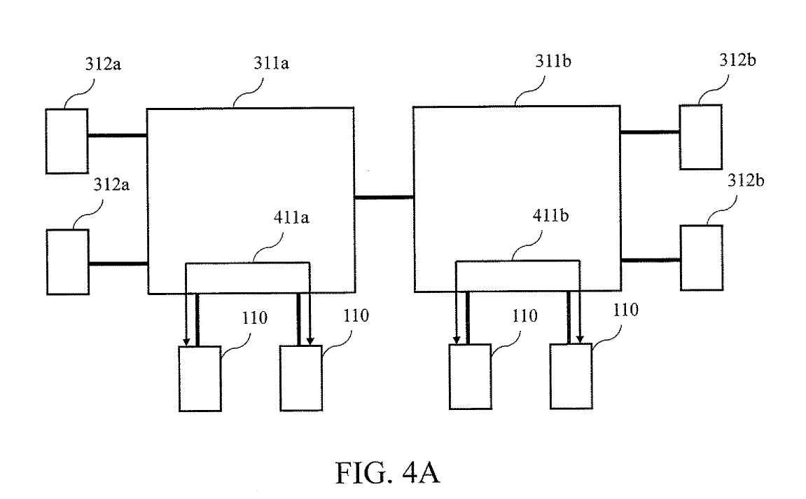

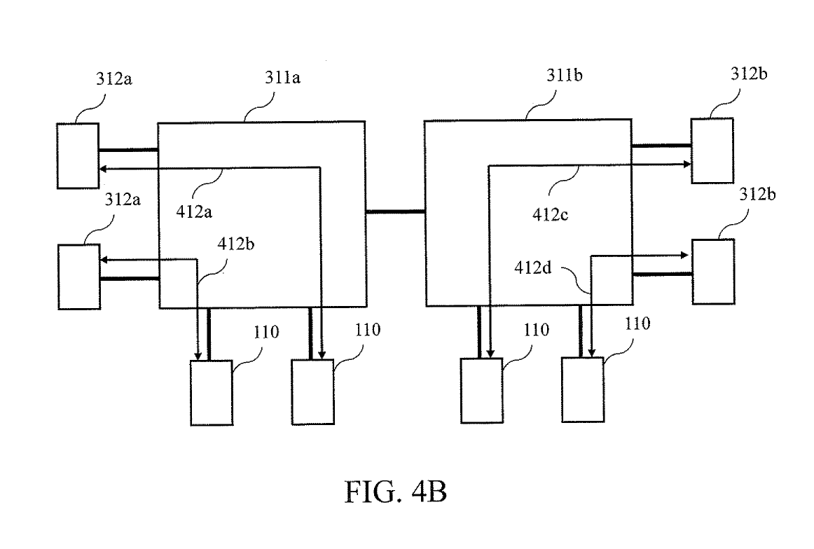

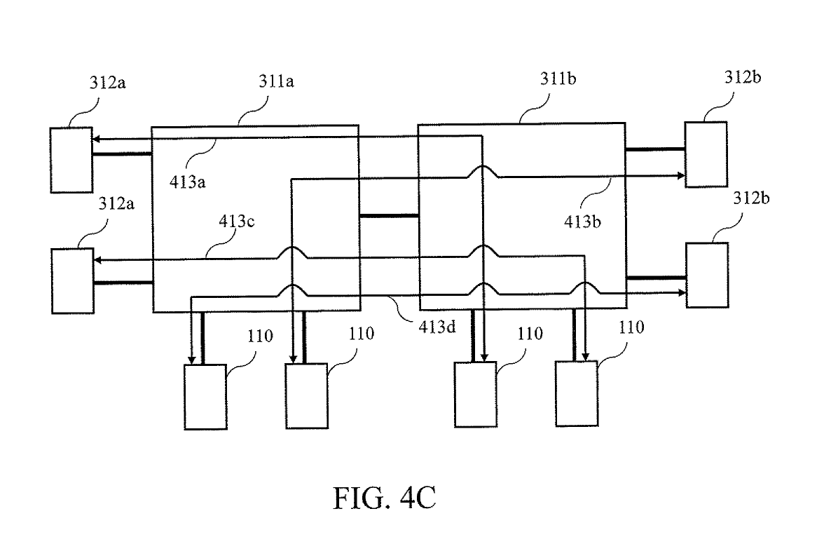

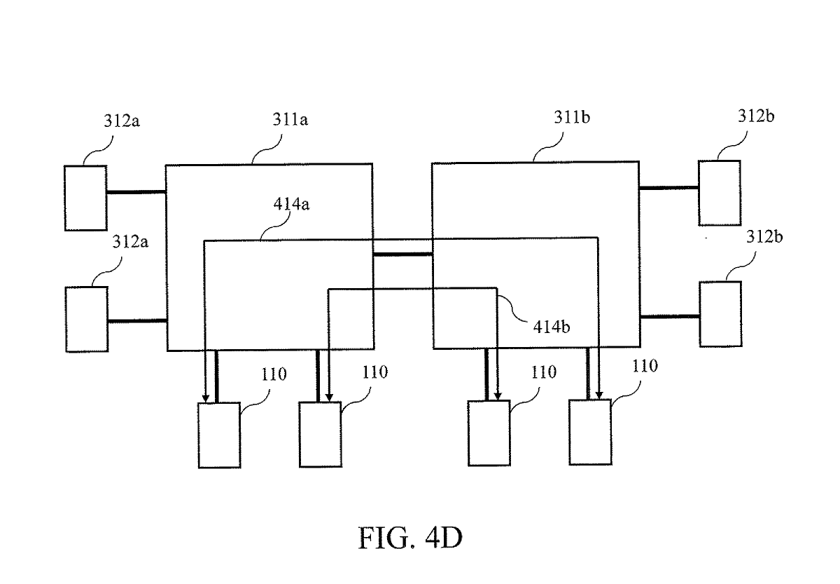

In the following, FIG. 3 and FIGS. 4A through 4D are illustrated to describe some embodiments of the present invention. Referring to FIG. 3 first, which is a schematic diagram for illustrating a bus pressure testing process applied on an environment having a CPU, a PCI-E device and a memory according to the present invention. First, the PCI-E device 110 of the present invention is arranged on a PCI-E device interface. After the PCI-E device 110 is activated, the initialization module 111 receives a test model provided by the user, and initializes the CPU 311, PCI-E device interface and memory 312. When the initialization module 111 is finished with the initialization process, the path module 112 establishes a data transmission path corresponding to the test model. Assume the current test model is based on a bus testing between the PCI-E device 110 and the CPU 311, then the established data transmission path is a path from the PCI-E, device 110 to the CPU 311. Thereafter, the producing module 113 produces a pressure data stream, and enables the pressure data stream to flow on the data transmission path for the pressure testing. In this manner, it may be exempted from taking up a too much portion of the processing time of the CPU 311 by the pressure testing task which the present invention refers to.

Referring to FIGS. 4A through 4D, which are schematic diagrams for illustrating a bus pressure testing process applied on an environment having multiple CPUs, multiple memories and multiple PCI-E devices according to the present invention. In real implementation, aside from the bus environment shown in FIG. 3 having the single CPU 311, memory 312 and PCI-E device interface, the environment having multiple CPUs 311a, 311b, multiple memories 312a, 312b and multiple PCI-E devices may also be applicable. At first, an example shown in FIG. 4A is taken for description, where four PCI-E device interfaces are all inserted with the PCI-E device 110 of the present invention and the test model is a bus testing among the PCI-E device interfaces of the same CPU. After the initialization process by the initialization module 111, the path module 112 establishes data transmission paths 411a, 411b corresponding to the test model, i.e. paths are established among the PCI-E devices of the same CPU. As such, the produced pressure data stream by the producing model 113 may be sent to flow on the data transmission paths 411a, 411b for pressure testing, which is schematically shown in FIG. 4A.

As mentioned above, assume the test model is associated with the buses among the PI-E device interfaces of the same CPU and the memories, after the initialization of the initialization module 111, the path module 112 of each of the PCI-E devices 110 will all establish data transmission paths 412a, 412b, 412c, 412d corresponding to the test model, i.e. the paths among the PI-E device interfaces of the same CPU and the memories are established. As such, the pressure data flow produced by the producing module 113 may be sent to flow on the data transmission paths 412a, 412b, 412, 412d for pressure testing, as is schematically shown in FIG. 4B.

Likely, the same work fashion may be extended to other cases. Assume the test model is associated with the buses among the PCI-E device interfaces of different CPUs and the memories, the path module 112 of each of the PCI-E devices 110 will all establish data transmission paths 413a, 413b, 413c, 413d corresponding to the test model, as shown in FIG. 4C, i.e. the paths among the PCI-E device interfaces of the different CPUs are established.

Assume the test model is associated with the buses among the PCI-E device interfaces of different CPUs, the path module 112 of each of the PCI-E devices 110 will all establish data transmission paths 414a, 414b corresponding to the test model, as shown in FIG. 4D, i.e. the paths among the PCI-E device interfaces of the different CPUs are established.

In view of the above, the bus pressure testing system and method have been disclosed as the above, and has the differences as compared to the prior art that the PCI-E device is used to initialize the CPU, PCI-E device interface and memory according to the testing module, generate a data transmission path corresponding to the testing module, produces a pressure data stream and transmitting the pressure data stream on the data transmission path for the bus pressure testing. As such, the issue encountered in the prior art may be overcome and the pressure testing may be enhanced in practicability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bus pressure testing system applied on a peripheral component interconnect express (PCI-E) device for testing a bus environment having at least a central processing unit (CPU), at least a PCI-E device interface and at least a memory, comprising:
an initialization module, receiving a testing model after the PCI-E device is activated and initializing the CPU, PI-E interface and memory according to the testing module;
a path module, generating a data transmission path corresponding to the testing module and comprising one of the PCI-E device interface to the CPU and the PCI-E device interface to the memory; and
a producing module, producing a pressure data stream transmitted on the data transmission path for the bus pressure testing.

2. The bus pressure testing system according to claim 1, wherein the data transmission path is under an environment having two CPUs each connected to two PCI-E device interface and two memories and is one of a path between the two PCI-E device interface of a same one of the two CPUs, a path among the two PCI-E device interface and the two memories of a same one of the two CPUs, and a path among the two PCI-E device interface and the two memories of the two CPUs.

3. The bus pressure testing system according to claim 1, further comprising an adjustment module receiving a pressure message and triggering the producing module to adjust a flow amount of the pressure data stream, a payload data size of the PCI-E DEVICE interface, a size of the memory and a size of a First In First Out (FIFO) queue according to the testing model.

4. The bus pressure testing system according to claim 1, wherein the initialization module initializes a data read/write address of the PCI-E device, and sets an address space of a base address register and/or requests an allocation of the memory.

5. The bus pressure testing system according to claim 1, wherein the pressure data stream is a dual direction data pressure stream of 16 GB/s.

6. A bus pressure testing method applied on a peripheral component interconnect express (PCI-E) device for testing a bus environment having at least a central processing unit (CPU), at least a PCI-E device interface and at least a memory, comprising steps of:
receiving a testing model after the PCI-E device is activated and initializing the CPU, PCI-E device interface and memory according to the testing module;
generating a data transmission path corresponding to the testing module and comprising one of the PCI-E device interface to the CPU and the PCI-E device interface to the memory; and
producing a pressure data stream transmitted on the data transmission path for the bus pressure testing.

7. The bus pressure testing method according to claim 6, wherein the data transmission path is under an environment having two CPUs each connected to two PCI-E device interface and two memories and is one of a path between the two PCI-E device interface of a same one of the two CPUs, a path among the two PCI-E device interface and the two memories of a same one of the two CPUs, and a path among the two PCI-E device interface and the two memories of the two CPUs.

8. The bus pressure testing method according to claim 6, further comprising a step of receiving a pressure message and triggering the producing module to adjust a flow amount of the pressure data stream, a payload data size of the PCI-E DEVICE interface, a size of the memory and a size of a First In First Out (FIFO) queue.

9. The bus pressure testing method according to claim 6, wherein the initialization module initializes a data read/write address of the PCI-E device, and sets an address space of a base address register and/or requests an allocation of the memory.

10. The bus pressure testing method according to claim 6, wherein the pressure data stream is a dual direction data pressure stream of 16 GB/s.
